(19) United States
(12) Patent Application Publication
(10) Pub. No.: US 2021/0004728 A1
(43) Pub. Date: Jan. 7, 2021

(54) DETERMINING ARRIVAL OF TRANSPORTATION PROVIDERS TO PICKUP LOCATIONS UTILIZING A HIKING DISTANCE PREDICTOR MODEL

(71) Applicant: Lyft, Inc., San Francisco, CA (US)

(72) Inventors: Andres Uribe Gonzalez, Brooklyn, NY (US); Alex Collier Mazure, San Francisco, CA (US); Mohammad Ali Motie Share, San Francisco, CA (US); Allen Lamson Nguyen, Long Island City, NY (US); Jimmy Young, San Francisco, CA (US)

(21) Appl. No.: 16/504,161

(22) Filed: Jul. 5, 2019

(51) Int. Cl. G06Q 10/02; G06Q 50/30; G08G 1/00

(52) U.S. Cl. CPC G06Q 10/02; G08G 1/202; G06Q 50/30

(57) ABSTRACT

This disclosure describes an arrival determination system that determines a hiking distance for a transportation request and further enables a provider device to indicate arrival for pickup based on monitoring a location of the provider device. For example, the disclosed systems utilize a hiking distance predictor model to analyze request features associated with a transportation request to determine a hiking distance based on the request features. In addition, the disclosed systems monitor a location of a provider device of a provider matched to service the transportation request to determine when the provider device is within the hiking distance of a requested pickup location. Based on determining that the provider device is within the hiking distance, the disclosed systems enable the provider device to notify a requester device that the provider has arrived for pickup.

### BACKGROUND

In recent years, both popularity and usage of on-demand transportation matching systems have increased. Indeed, the proliferation of web and mobile applications has enabled requesting individuals to request transportation from one geographic location to another. For instance, an on-demand transportation matching system can receive transportation requests and can pair the requests with providers that can transport requesting individuals to destination locations.

Despite the advances of these systems, conventional on-demand transportation systems continue to suffer from a number of disadvantages, particularly in their accuracy, efficiency, and flexibility. As an initial problem, conventional on-demand transportation systems often generate inaccurate determinations of a transportation provider arriving at a pickup location. To elaborate, while these conventional systems can provide notifications of a provider's arrival to a pickup location, these conventional systems nevertheless generate such notifications fraudulently when providers are not actually at a pickup location. For example, some conventional systems generate faulty notifications of provider arrival by utilizing a uniform distance threshold where a requester may be informed of a provider's arrival when the provider vehicle is within the threshold but not actually at the pickup location. Indeed, in some cases, the uniform distance thresholds used by conventional systems are either too large (e.g., in dense downtown areas where driving is slow and there are many streets) or too small (e.g., in rural areas where driving is fast and there are fewer streets or where the requested location is in the middle of a venue). For instance, a provider may be merely passing by the pickup location on a nearby road on route to the pickup location (e.g., on a freeway overpass or on the same road in the opposite direction) or stuck in heavy traffic—the provider is within the distance threshold but, in some cases, may still be minutes away from pickup.

In addition, conventional on-demand transportation systems are inefficient. Particularly, conventional systems require excessive computation power and computation time. For example, many conventional systems receive, process, and match excessive numbers of transportation requests and cancelations due to faulty or fraudulent indications of provider arrival. Indeed, in cases where conventional systems incorrectly notify a requester that a provider has arrived at a pickup location, the requester may cancel the request upon realization that the provider has not arrived for pickup in actuality. Thus, due at least in part to their inaccuracy, these systems inefficiently utilize computing resources such as processing power and processing time for handling excessive request cancelations and subsequent redundant requests for transportation to make up for those requests that are canceled.

Further, conventional on-demand transportation systems are inflexible. In particular, conventional systems often rigidly apply a uniform distance threshold for determining whether a provider has arrived at a pickup location. Thus, because of their rigid nature, conventional systems cannot adapt to modify a distance threshold on a per-request basis to accommodate request-specific circumstances that may otherwise affect the distance threshold.

These, along with additional problems and issues, exist with conventional on-demand transportation systems.

### SUMMARY

This disclosure describes one or more embodiments of methods, non-transitory computer-readable media, and systems that solve the foregoing problems in addition to providing other benefits. While this summary refers to systems for simplicity, the summary also applies to certain disclosed methods and non-transitory computer-readable media. To solve the foregoing and other problems, the disclosed systems can determine provider arrivals to pickup locations by utilizing a hiking distance predictor model. In particular, the disclosed systems can utilize a hiking distance predictor model to determine a distance threshold for a specific transportation request that a provider device must be within (or substantially near) to indicate arrival of a provider to a pickup location. For example, the disclosed systems can determine a hiking distance from a requested pickup location based on information associated with historical transportation requests, including hiking distances that previous requesters had to travel from a requested pickup location to an actual pickup location. Indeed, in some embodiments, the disclosed systems train the hiking distance predictor model based on historical transportation requests. By thus utilizing the hiking distance predictor model, the disclosed systems can more accurately determine when a provider has arrived at a pickup location on a per-request basis.

The following description sets forth additional features and advantages of one or more embodiments of the disclosed methods, non-transitory computer-readable media, and systems. In some cases, such features and advantages are evident to a skilled artisan from the description or learned by the practice of the disclosed embodiments.

### BRIEF DESCRIPTION OF THE DRAWINGS

The detailed description refers to the drawings briefly described below.

FIG. 1 illustrates a block diagram of an environment for implementing a dynamic arrival determination system in accordance with one or more embodiments.

FIG. 2 illustrates an example sequence of acts associated with the arrival determination system in accordance with one or more embodiments.

FIG. 3 illustrates an example flow for determining a hiking distance utilizing a hiking distance predictor model in accordance with one or more embodiments.

FIG. 4 illustrates an example requester device for indicating a requested pickup location in accordance with one or more embodiments.

FIG. 5A illustrates an example illustration of determining a region associated with a requested pickup location in accordance with one or more embodiments.

FIG. 5B illustrates an example illustration of regions associated with determining hiking distances in accordance with one or more embodiments.

FIG. 6A illustrates an example provider device displaying the provider device outside a hiking distance in relation to a requested pickup location in accordance with one or more embodiments.

FIG. 6B illustrates an example provider device displaying the provider device within a hiking distance in relation to a requested pickup location in accordance with one or more embodiments.

FIG. 7 illustrates an example process for training a hiking distance predictor model in accordance with one or more embodiments.

FIG. 8 illustrates an example architecture for an arrival determination system in accordance with one or more embodiments.

FIG. 9 illustrates a block diagram of an example computing device including various components of an arrival determination system in accordance with one or more embodiments.

FIG. 10 illustrates an example flow of acts for determining a hiking distance and enabling a provider device to indicate provider arrival based on a location of the provider device in accordance with one or more embodiments.

FIG. 11 illustrates a block diagram of a computing device for implementing one or more embodiments of the present disclosure.

FIG. 12 illustrates an example environment for a transportation matching system in accordance with one or more embodiments.

### DETAILED DESCRIPTION

This disclosure describes a dynamic arrival determination system that can utilize a hiking distance predictor model to determine arrival of a provider to a requested pickup location based on historical hiking distances associated with historical transportation requests. For example, the arrival determination system can determine a hiking distance for a received transportation request based on hiking distance of historical transportation requests. Indeed, the arrival determination system can utilize a hiking distance predictor model to determine a distance threshold that defines a distance from a requested pickup location within which a provider can notify a requester that they have arrived for pickup. In some embodiments, upon detecting that the provider is within the hiking distance of the requested pickup location, the arrival determination system enables or causes a provider device to display a selectable option to notify a requester that the provider has arrived.

As mentioned, the arrival determination system can determine hiking distance for a received transportation request. For example, the arrival determination system can determine a distance away from a requested pickup location that a provider device can be located to enable (or cause) the provider device to present a selectable option to indicate that the provider has arrived at the pickup location (e.g., by sending a notification to a requester device). Indeed, the arrival determination system can receive a transportation request from a requester device that indicates a requested pickup location and that includes other transportation request information or request features as well such as a selection method for the requested pickup location (e.g., a pin drop, a manually entered address, a venue, or a search), a region associated with the requested pickup location, a time of day, and a requester distance from the requested pickup location, among others.

To determine the hiking distance, the arrival determination system can utilize a hiking distance predictor model to analyze the request features. Indeed, the arrival determination system can utilize a hiking distance predictor model to determine or predict a hiking distance for a transportation request based on the request features of the transportation request. For example, the arrival determination system can input the request features into the hiking distance predictor model, whereupon the hiking distance predictor model generates a hiking distance for the request. Thus, for subsequent transportation requests, the arrival determination system determines corresponding request features and determines hiking distances on a per-request basis, where each hiking distance may be different.

The arrival determination system can further train the hiking distance predictor model to generate accurate predictions or determinations of hiking distances. Indeed, the arrival determination system can train the hiking distance predictor model based on training request features of historical transportation requests and corresponding ground truth hiking distances of the historical transportation requests. For example, the arrival determination system can collect historical information for a plurality of historical transportation requests on a region-specific basis to determine hiking distances for the historical transportation requests. Utilizing the historical hiking distances (in addition to other training request features), the arrival determination system can train the hiking distance predictor model to determine hiking distances for transportation requests.

In some embodiments, the arrival determination system monitors a location of an assigned provider. Indeed, the arrival determination system can assign a provider to service the transportation request and can monitor the location of the provider by periodically requesting location information from a provider device. Based on determining that the provider device is within the hiking distance from the requested pickup location, the arrival determination system can enable the provider (or the provider device) to indicate arrival at the requested pickup location for picking up the requester. In some embodiments, upon detecting or determining that the provider device (or the provider transportation vehicle) is within the hiking distance of the requested pickup location, the arrival determination system causes the provider device to present a selectable option to notify the requester that the provider has arrived for pickup. Upon detecting such a selection of the option, the arrival determination system notifies the requester that the provider has arrived by causing the requester device to display a notification of provider arrival.

As outlined above, the arrival determination system provides several advantages and benefits over conventional on-demand transportation systems. For instance, the arrival determination system improves accuracy over conventional systems by utilizing a hiking distance predictor model to determine request-specific hiking distances. Indeed, the arrival determination system determines hiking distances based on a number of request features, as opposed to conventional systems that utilize a uniform, one-size-fits-all distance threshold. By more accurately determining hiking distances, the arrival determination system thus more accurately enables providers to notify requesters of arrival for pickup. Therefore, the arrival determination system reduces fraudulent or faulty arrival notifications, including in high density areas like cities (where the hiking distance for a request may be relatively short) as well as low density rural areas (where the hiking distance may be longer).

In addition, the arrival determination system improves efficiency over conventional systems. For example, while some conventional on-demand transportation systems process large numbers of cancelations and redundant transportation requests due to those cancelations (as a result of fraudulent arrival notifications), the arrival determination system reduces the computation time and computation power required to determine pickup locations at least in part by being more accurate. Indeed, the arrival determination system processes fewer transportation requests and fewer post-arrival cancelations (cancelations after a provider has indicated arrival) than conventional systems because the arrival determination system is more reliable in accurately notifying a requester that a provider has arrived for pickup. For instance, the arrival determination system reduces faulty or fraudulent arrival notifications, which thereby reduces the number of cancelations and subsequent post-cancelation requests. By processing fewer requests and cancelations, the arrival determination system thus reduces computer resources such as computation time and computation power. The arrival determination system further improves throughput of transportation requests and improves market dynamics by reducing the number of post-arrival cancelations.

Further, the arrival determination system improves flexibility over conventional systems. Particularly, the arrival determination system flexibly adapts the determination of hiking distances for each transportation request independently. Indeed, the arrival determination system utilizes a hiking distance predictor model to determine a hiking distance for each received request independently. Indeed, the arrival determination system applies the hiking distance predictor model to the unique request features of each received request to determine request-specific hiking distances. Accordingly, rather than rigidly applying a uniform distance threshold as is done in many conventional systems, the arrival determination system flexibly adjusts to tailor the determination of hiking distances on a per-request basis.

As illustrated by the foregoing discussion, the present disclosure utilizes a variety of terms to describe features and advantages of the arrival determination system. For reference, additional detail is now provided regarding the use and definition of these terms. For example, as used herein, the term “hiking distance” refers to a distance between a requested pickup location and an actual pickup location for a given transportation request. In particular, a hiking distance can include a maximum distance that a requester is willing to walk (or otherwise travel) from a requested pickup location to meet a transportation vehicle. For example, a hiking distance can define a threshold distance from a requested pickup location associated with a transportation request that a provider device must be within to trigger indication of provider arrival for the transportation request. As another example, a hiking distance can define a no-show eligibility distance—i.e., threshold distance from a requested pickup location that a provider device must be within to enable the provider device to provide a no-show indication to cancel a transportation request if a requester does not arrive for pickup at the pickup location. In some embodiments, a hiking distance refers to a three-dimensional distance including a latitude component, a longitude component, and a height component. Thus, when the arrival determination system determines that a provider device is within a hiking distance from a requested pickup location, the arrival determination system causes the provider device to present a selectable option to indicate that the provider has arrived at the requested pickup location to pick up a requester.

Relatedly, the term “requested pickup location” refers to a geographic location that a requester indicates as a location that the requester desires to get picked up for a transportation request. For example, a requested pickup location can include a geographic coordinate location along a street or sidewalk. A requester can indicate a requested pickup location by dropping a pin within a digital map on a requester device, by entering a location search query, by manually entering an address, or by identifying or searching for a venue. The term “actual pickup location” refers to a geographic location that a requester is actually picked up for a transportation request. For example, an actual pickup location can include a geographic coordinate location where a requester device and a provider device intersect (share a common location)—e.g., where a requester enters a provider transportation vehicle for a given request. An actual pickup location can differ from a requested pickup location because a provider may not arrive exactly at the requested pickup location when a requester enters the transportation vehicle to begin the transportation service.

As used herein, the term “contextual request information” (or sometimes simply “transportation request information” or “request information”) refers to information associated with a context of a transportation request. For example, contextual request information can include profile information associated with a requester, such as a name, a username, a home address, a work address, a gender, an occupation, and/or an age associated with a requester. Contextual request information can also (or alternatively) include information such as a coordinate location (e.g., latitude, longitude, and height) of a transportation request, a pickup location selection method (e.g., a pin drop on a map, a typed address, or a searched location) of a transportation request, a coordinate of a selected pickup location, a time of day of a transportation request, provider availability information (e.g., locations and availability statuses of provider devices), event information, traffic information, weather information, construction information, and/or navigability information (e.g., availability of sidewalks, availability of crosswalks, roughness of surrounding terrain for requesters to walk) that affects provider navigation and/or requester navigation to pickup locations. Indeed, the arrival determination system can determine a hiking distance for a transportation request based on historical hiking distances for transportation requests sharing some or all of the contextual request information of the transportation request.

As mentioned, the arrival determination system can determine a hiking distance by utilizing a hiking distance predictor model. As used herein, the term “hiking distance predictor model” refers to a machine learning model that generates a hiking distance based on a given input of request features. For example, a hiking distance predictor model can include a regression model (e.g., a quantile regression model) that predicts a maximum distance that a requester will walk from a requested pickup location to an actual pickup location where the requester meets a provider to enter a provider vehicle. In some embodiments, the hiking distance predictor model includes a gradient boosting machine or “GBM” (e.g., a lightGBM).

As also mentioned, the arrival determination system generates or determines a hiking distance for a transportation request based on request features of the transportation request. As used herein, the term “transportation request feature” (or simply “request feature”) refers to a feature or piece of information for determining a hiking distance. A request feature can include a feature included within a transportation request (e.g., transportation request information) and/or features otherwise associated with a transportation request (e.g., predetermined features related to historical transportation requests within a particular region). In some embodiments, a request feature includes features such as a requested pickup location selection method, a requester device distance from the requested pickup location, a time of day (e.g., an hour local time or a shifted hour local time), a geographic region associated with the transportation request, a region-specific hiking distance (e.g., a hiking distance for a given quantile associated with a geographic region), or a region-specific number of serviced transportation requests. The arrival determination system can utilize a request feature as input into a hiking distance predictor model for determining a hiking distance.

As mentioned, the arrival determination system trains the hiking distance predictor model based on training request features from historical transportation requests. As used herein, the term “historical” (e.g., when used as a modifier such as “historical transportation request” or “historical requested pickup location”) refers to an event that occurred in the past or previously. Relatedly, the term “train” refers to utilizing information to tune or teach a machine learning model (e.g., a hiking distance predictor model). The term “training” (when used as an adjective or descriptor, such as in “training data” or “training request feature”) refers to information or data utilized to tune or teach the hiking distance predictor model.

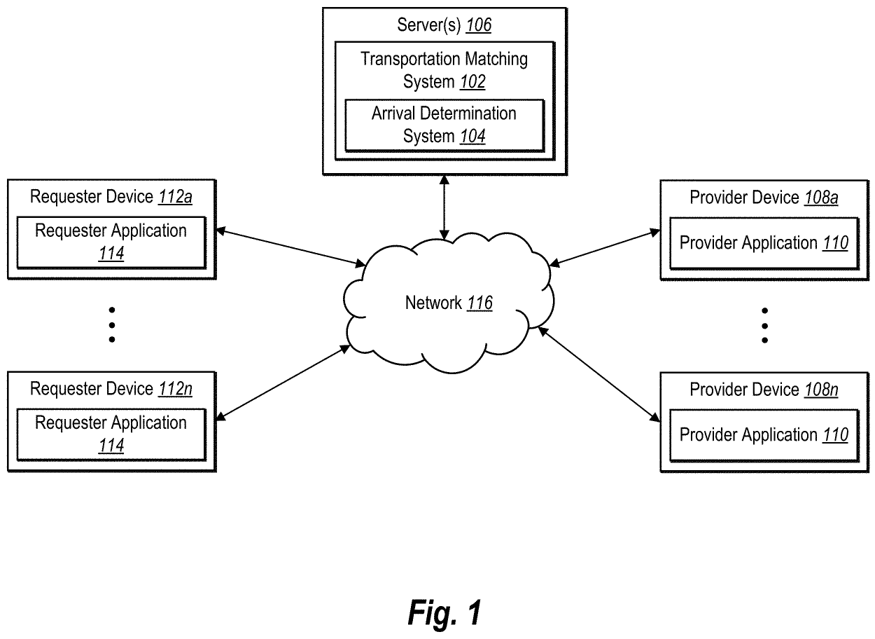

Additional detail will now be provided with reference to the figures. The description with respect to FIG. 1 provides an overview of the arrival determination system. Thereafter, much of the disclosure describes components and processes of the arrival determination system in further detail with reference to subsequent figures.

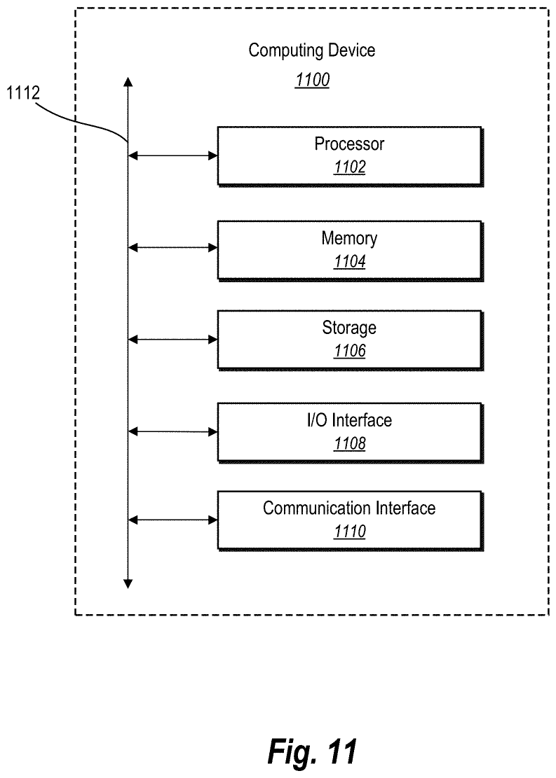

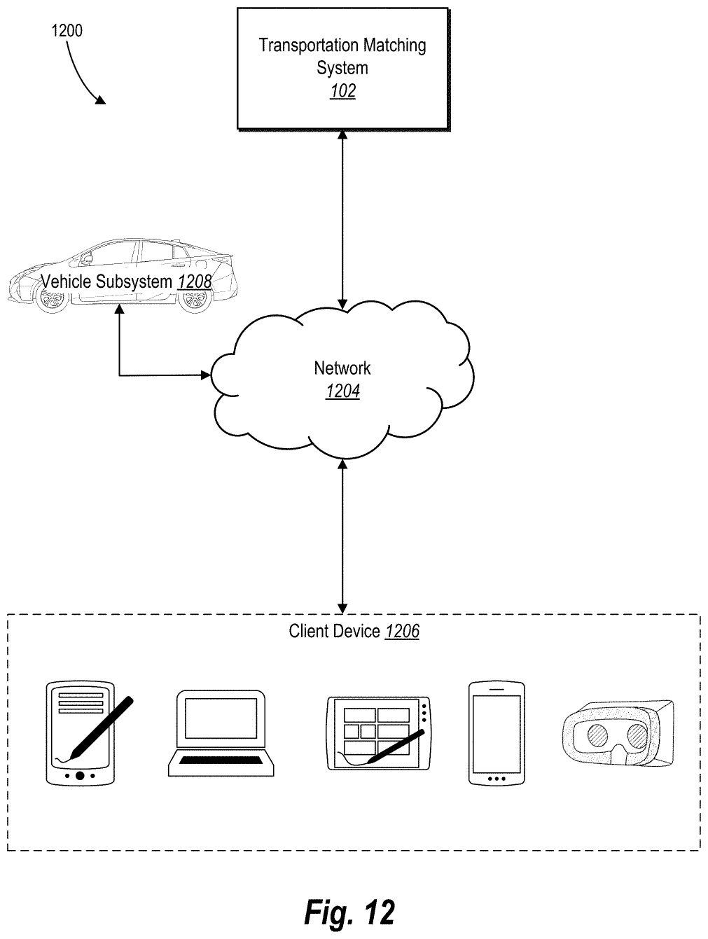

To illustrate, FIG. 1 includes a block diagram of an environment for implementing an arrival determination system 104 in accordance with one or more embodiments. As shown in FIG. 1, the environment includes the server(s) 106 housing the arrival determination system 104 as part of a transportation matching system 102. The environment of FIG. 1 further includes provider devices 108a-108n, requester devices 112a-112n, and a network 116. The server(s) 106 can include one or more computing devices to implement the arrival determination system 104. Additional description regarding the illustrated computing devices (e.g., the server(s) 106, the requester devices 112a-112n, and the provider devices 108a-108n) is provided with respect to FIGS. 11-12 below.

As shown, the arrival determination system 104 utilizes the network 116 to communicate with the provider devices 108a-108n and the requester devices 112a-112n. For example, the arrival determination system 104 communicates with the provider devices 108a-108n and the requester devices 112a-112n via the network 116 to match transportation requests with transportation providers. In some embodiments, per device settings, the arrival determination system 104 receives device information from the provider devices 108a-108n and requester devices 112a-112n such as location coordinates (e.g., latitude and longitude) and status (currently transporting/riding, not transporting/riding, available, or unavailable).

To facilitate connecting requests with transportation provider vehicles, arrival determination system 104 further communicates with the provider devices 108a-108n (e.g., through a provider application 110) and with the requester devices 112a-112n (e.g., through a requester application 114). Indeed, as shown in FIG. 1, each of the provider devices 108a-108n include a provider application 110. In many embodiments, the arrival determination system 104 communicates with the provider devices 108a-108n through the provider application 110 to, for example, receive and provide information including request information and provider information. Additionally, the provider application 110 optionally includes computer-executable instructions that, when executed by the provider devices 108a-108n, cause the provider devices 108a-108n to perform certain functions. For instance, the provider application 110 can cause the provider devices 108a-108n to communicate with the arrival determination system 104 to navigate to various places such as a requested pickup location, a requester's destination location, as well as collect fares and bonuses for completed transportation requests. The arrival determination system 104 can further communication with the provider application 110 to cause the provider application to present a graphical user interface that includes certain elements such as a digital map of a requested pickup location and/or a selectable option to notify a requester of arrival for pickup (upon detecting that the respective provider device is within a hiking distance of the requested pickup location).

Relatedly, as mentioned above, each of the requester devices 112a-112n includes a requester application 114. In many embodiments, the transportation matching system 102 communicates with the requester devices 112a-112n through the requester application 114 to, for example, receive and provide information including request features such as a request location, a requested pickup location, a request time, a region of a requested pickup location (e.g., a geohash or “GH” region of a requested pickup location), a requested pickup location selection method (e.g., a pin drop within a digital map, a manually entered address, a location search, or a venue), a destination location, a requester identification, and an actual pickup location, a provider ETA, and an estimated cost. A requester may use a requester application 114 to, via a requester interface, request transportation services, receive a price estimate for the transportation service, and access other transportation-related services. For example, a requester may interact with the requester device 112a through graphical user interfaces of the requester application 114 to enter a requested pickup location and a destination for transportation. The arrival determination system 104 can, in turn, provide to the requester device 112a, an estimated time of arrival of a provider (or transportation vehicle), a notification of a provider's arrival to a requested pickup location, or access to other transportation-related services through the requester application 114.

Although FIG. 1 illustrates the environment having a particular number and arrangement of components associated with the arrival determination system 104, in some embodiments the environment may include more or fewer components with varying configurations. For example, in some embodiments, the environment includes a database either stored on the server(s) 106 or elsewhere in the environment, linked via the network 116. The database can include training data for training a hiking distance predictor model. To that point, the environment can also include a hiking distance predictor model housed on the server(s) 106 or elsewhere in the environment. In these or other embodiments, the environment can include an administrator device that can communicate with the server(s) 106 to set one or more parameters associated with the arrival determination system 104.

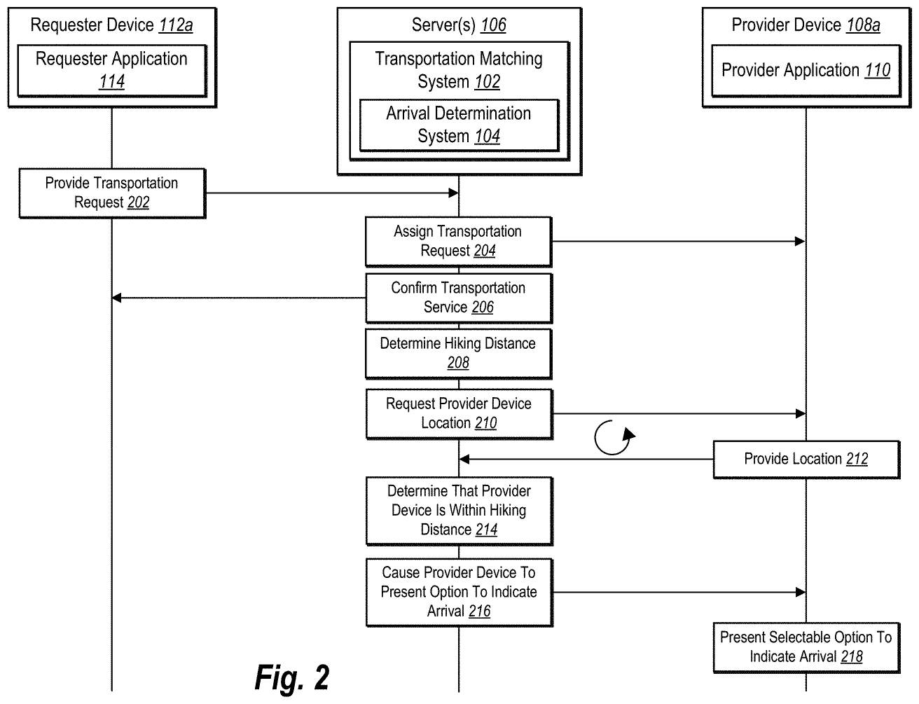

As mentioned, the arrival determination system 104 can enable a provider device to notify a requester of a provider's arrival to a requested pickup location based on determining that the provider device is within a hiking distance of the requested pickup location. Indeed, FIG. 2 illustrates an example sequence of acts performed by various components such as the requester device 112a, the arrival determination system 104, and the provider device 108a as part of determining a hiking distance for a transportation request, detecting when the provider device 108a is within the hiking distance of a requested pickup location, and causing the provider device 108a to present a selectable option to indicate arrival based on detecting that the provider device 108a is within the hiking distance.

As illustrated in FIG. 2, the requester device 112a performs an act 202 to provide a transportation request to the arrival determination system 104. For example, the requester device 112a receives input from a requester via the requester application 114 to input a requested pickup location using a particular method. In some embodiments, the requester interacts with a digital map presented via the requester application 114 to drop a pin at a requested pickup location. Alternatively, the requester manually enters an address within the requester application 114, utilizes a location search function of the requester application by entering a search query within a search bar, or else searches for and/or selects a particular venue as a requested pickup location. In some embodiments, the requester indicates a requested pickup location as a location of the requester device 112a when the request is submitted (i.e., a request location).

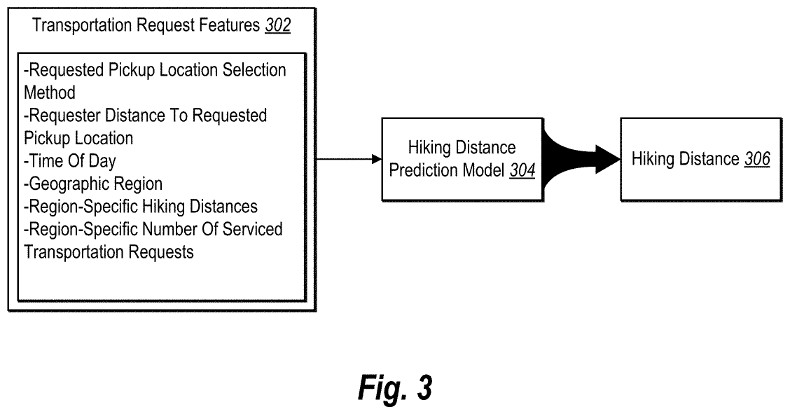

In response to the act 202, the arrival determination system 104 receives the transportation request from the requester device 112a. Indeed, the arrival determination system 104 receives the transportation request along with a number of request features included with the transportation request such as a coordinate location of a requested pickup location, a region associated with the requested pickup location, a requested pickup location selection method, and/or a time of day of the request. In addition, the arrival determination system 104 determines other request features associated with the transportation request that the arrival determination system 104 utilizes for determining a hiking distance. For instance, the arrival determination system 104 determines, as request features, historical hiking distances associated with different-sized regions of the requested pickup location. Additional detail regarding the request features utilized for determining a hiking distance is provided below with reference to FIG. 3.

As shown in FIG. 2, the arrival determination system 104 performs an act 204 to assign the transportation request to the provider device 108a. For example, the arrival determination system 104 selects the provider associated with the provider device 108a to service the transportation request based on a number of factors including a location of the provider device 108a, the requested pickup location, a location of the requester device 112a, and/or other request features.

Additionally, the arrival determination system 104 performs an act 206 to confirm transportation service. In particular, the arrival determination system 104 provides a notification to the requester device 112a to indicate that the arrival determination system 104 has assigned the provider associated with the provider device 108a to service the transportation request. Thus, the requester device 112a presents, via the requester application 114, a notification that the transportation request has been assigned and that the provider is on route for pickup. The arrival determination system 104 can provide additional information as part of the confirmation including an ETA of the provider to the requested pickup location, an estimated cost, and provider information (e.g., name, type of vehicle, and color of vehicle).

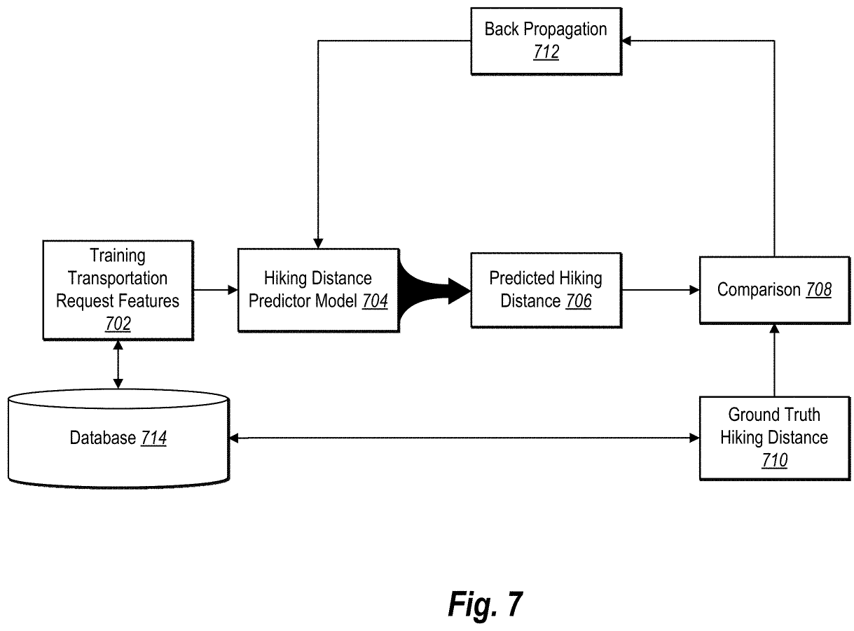

As further shown, the arrival determination system 104 performs an act 208 to determine a hiking distance for the transportation request. To elaborate, the arrival determination system 104 determines a hiking distance from a requested pickup location of the transportation request. To determine the hiking distance, the arrival determination system 104 utilizes a hiking distance predictor model. For example, the arrival determination system 104 utilizes a hiking distance predictor model to analyze request features and generate a hiking distance based on the request features. In some embodiments, the arrival determination system 104 further trains the hiking distance predictor model to generate accurate predictions or determinations of hiking distances for transportation requests. Additional detail regarding utilizing the hiking distance predictor model to generate a hiking distance is provided below with reference to FIG. 3. Thereafter, additional detail regarding training the hiking distance predictor model is provided with reference to FIG. 7.

Based on determining the hiking distance, the arrival determination system 104 monitors a location of the provider device 108a to determine or detect when the provider device 108a is within the hiking distance from the requested pickup location. For example, the arrival determination system 104 performs an act 210 to request a provider device location from the provider device 108a. In response to the request, the provider device 108a performs an act 212 to provide the location of the provider device 108a. As shown, the arrival determination system 104 and the provider device 108a can repeat the acts 210 and 212 to continuously monitor the location of the provider device 108a. In some embodiments, the arrival determination system 104 performs the act 210 at a set interval (e.g., every 1 second or every 5 seconds) to receive location updates for the provider device 108a. In other embodiments, the arrival determination system 104 continually monitors the location of the provider device 108a to determine when the provider device 108a transitions from outside a hiking distance to inside a hiking distance.

As further illustrated in FIG. 2, the arrival determination system 104 performs an act 214 to determine that the provider device 108a is within the hiking distance of the requested pickup location. To elaborate, based on monitoring the location of the provider device 108a, the arrival determination system 104 determines when the provider device 108a is at a location that is within the hiking distance of the requested pickup location. Based on this determination, the arrival determination system 104 performs an act 216 to cause the provider device 108a to present an option to indicate provider arrival. More specifically, the arrival determination system 104 enables or causes the provider device 108a to display a selectable option (e.g., an “I'm Here” button) within a provider interface of the provider application 110 to notify the requester that the provider has arrived for pickup. Until the provider device 108a is within the hiking distance of the requested pickup location, however, the arrival determination system 104 prevents the provider device 108a from enabling or causing presentation of a selectable option to indicate that the provider has arrived at the requested pickup location to pick up the requester.

Based on the act 216, the provider device 108a performs an act 218 to present a selectable option to indicate arrival of the provider at the requested pickup location. For example, the provider device 108a displays a button that, when selected by the provider, indicates to the arrival determination system 104 to notify the requester (via the requester device 112a) that the provider has arrived for pickup. Thus, in response to detecting input in the form of a selection of the selectable option (or receiving an indication of a selection of the selectable option), the arrival determination system 104 provides a notification to the requester device 112a that the provider has arrived for pickup to service the transportation request.

In some embodiments, the arrival determination system 104 continues to monitor the location of the provider device 108a after determining that the provider device 108a is within the hiking distance of the requested pickup location. For example, the arrival determination system 104 continues to repeat the acts 210 and 212 even throughout the performance of other acts illustrated in FIG. 2 (e.g., on a set interval). Upon determining that that the provider device 108a leaves the area within the hiking distance of the requested pickup location, the arrival determination system 104 revokes (e.g., causes the provider device 108a to remove from display) the option to notify the requester that the provider has arrived for pickup. Indeed, in some cases, the arrival determination system 104 determines that the provider device 108a is within the hiking distance at one point in time and then later determines (e.g., on a subsequent location request of act 210) that the provider device 108a is no longer within the hiking distance at a subsequent point in time.

In these or other embodiments, the arrival determination system 104 waits for a number of consecutive location requests (e.g., act 210) that indicate that the provider device 108a is within the hiking distance before providing a notification to the requester device 112a that the provider has arrived. For example, even after receiving an indication of a selection of a selectable option to notify the requester of provider arrival, the arrival determination system 104 waits for a threshold number of consecutive location requests that indicate that the provider device 108a is within the hiking distance before then providing the notification to the requester device 112a. In some embodiments, the arrival determination system 104 waits for a consecutive number of location requests that indicate that the provider device 108a is within the hiking distance before even performing the act 216 to cause the provider device 108a to present a selectable option to indicate provider arrival. In this way, the arrival determination system 104 can reduce faulty or fraudulent arrival indications to an even greater degree.

As mentioned, the arrival determination system 104 can receive additional transportation requests from the same or other requester devices (e.g., requester devices 112b-112n). For example, the arrival determination system 104 receives a second transportation request and matches the transportation request to a provider associated with a second provider device 108b. In addition, the arrival determination system 104 utilizes the hiking distance predictor model to determine a second hiking distance for the second transportation request. Indeed, the arrival determination system 104 determines a different hiking distance for the second transportation request than for the first transportation request because each transportation request has different request features. Based on the second hiking distance, in much the same way as described above, the arrival determination system 104 determines when the second provider device 108b is within the second hiking distance of the second requested pickup location and, in turn, causes the second provider device 108b to present a selectable option to notify the requester of arrival.

In some embodiments, the arrival determination system 104 can determine an upper bound for a hiking distance and a lower bound for a hiking distance. For example, the arrival determination system 104 can utilize a hiking distance predictor model to determine a hiking distance within a given quantile of hiking distances, where the upper bound is the upper limit of the quantile and the lower bound is the lower limit of the quantile. In some embodiments, rather than generating an upper bound and a lower bound, the arrival determination system 104 generates a first hiking distance (e.g., to use as a first threshold distance) and a second hiking distance (e.g., to use as a second threshold distance) for a given transportation request. For instance, the arrival determination system 104 determines two hiking distances that can trigger different behavior by a provider device (e.g., the provider device 108a).

To elaborate, the arrival determination system 104 determines a first larger hiking distance and a second smaller hiking distance, and the arrival determination system 104 further determines when the provider device 108a is within the first larger hiking distance and/or the second smaller hiking distance. Based on determining that the provider device 108a is within the first larger hiking distance and not within the second smaller (i.e., between the two hiking distances), the arrival determination system 104 causes the provider device 108a to present, enable, or display a selectable option to indicate arrival. Additionally, in one or more embodiments, the arrival determination system 104 determines whether the provider selects the selectable option to indicate arrival.

In some cases, the arrival determination system 104 determines that the provider does not select the selectable option (i.e., based on not receiving an indication of a selection of the selectable option). Further, the arrival determination system 104 determines whether the provider device 108a is within the second smaller hiking distance. Based on determining that the provider device 108a is within the second smaller hiking distance and/or that no indication of a selection of the selectable option was received from the time the provider device 108a entered the first larger hiking distance to the time the provider device 108a entered the second smaller hiking distance, the arrival determination system 104 automatically (i.e., without additional provider input) provides an arrival notification to the requester device 112a and/or updates the selectable option automatically to indicate that the transportation provider has arrived.

As mentioned above, the arrival determination system 104 can utilize a hiking distance predictor model to determine a hiking distance for a received transportation request. Indeed, FIG. 3 illustrates an example flow of generating a hiking distance based on transportation request features 302 from a received transportation request. Particularly, the arrival determination system 104 receives the transportation request along with a number of request features included with the transportation request such as a coordinate location of a requested pickup location, a region (e.g., a geohash region such as a GH-6, a GH-7, or a GH-8) associated with a requested pickup location, a requested pickup location selection method, a local time of day of the transportation request (e.g., an hour of the day in a respective time zone), and/or a shifted time of day (e.g., an hour of the day in the respective time zone plus 12 and divided by 24).

In addition, the arrival determination system 104 determines other request features associated with the transportation request that the arrival determination system 104 utilizes for determining a hiking distance. For instance, the arrival determination system 104 determines, as request features, historical hiking distances over a certain period of time (e.g., the previous 2 or 3 years) and/or contextual request information associated with different-sized regions that include the requested pickup location. To illustrate, the arrival determination system 104 determines region-specific hiking distances (e.g., hiking distances for regions of different sizes or resolutions that include the requested pickup location) based on historical transportation requests that indicate historical requested pickup locations and corresponding historical actual pickup locations.

For example, the arrival determination system 104 determines, based on the location of the requested pickup location and/or the contextual request information, a GH-6 median hiking distance, a GH-7 median hiking distance, a GH-8 median hiking distance, a GH-6 75^{th} percentile of hiking distances, a GH-7 75^{th} percentile of hiking distances, a GH-8 75^{th} percentile of hiking distances, a GH-6 95^{th} percentile of hiking distances, a GH-7 95^{th} percentile of hiking distances, and/or a GH-8 95^{th} percentile of hiking distances. Further, the arrival determination system 104 determines, based on the requested pickup location, a GH-6 total number of completed or serviced transportation requests, a GH-7 total number of completed transportation requests, and a GH-8 total number of completed transportation requests. In some embodiments, the arrival determination system 104 determines other region-specific hiking distance corresponding to different quantiles or percentiles.

In the same or other embodiments, the arrival determination system 104 determines request features 302 in the form of contextual request information as well. For example, the arrival determination system 104 determines request features 302 such as a provider device distance from a requested pickup location, a provider device distance from a request location, a requester device distance from a requested pickup location, a distance (e.g., real-time distance) between a requester device and a provider device, a requester device distance from a requested pickup location at a time of provider arrival, three-dimensional requester location information (e.g., including a height in a tall building that affects hiking distance to a requested pickup location), and/or other contextual request information described above.

As illustrated in FIG. 3, the arrival determination system 104 utilizes the request features 302 as input into the hiking distance predictor model 304. Thus, the arrival determination system 104 utilizes the hiking distance predictor model 304 to analyze the request features 302 to generate the hiking distance 306 based on the request features 302. To elaborate, the hiking distance predictor model 304 implements a quantile regression technique to predict a quantile of hiking distances that corresponds to the request features 302. For example, the hiking distance predictor model 304 includes one or more layers (e.g., input layers, hidden layers, and output layers) that analyze the request features 302 based on training to generate predictions or likelihoods of the request features 302 corresponding to each respective quantile of hiking distances (e.g., a median, a 75^{th} percentile, or a 95^{th} percentile). In some embodiments, the hiking distance predictor model 304 selects the quantile with the highest probability or likelihood as the quantile of hiking distances that corresponds to the request features 302. Thus, in these or other embodiments the arrival determination system 104 determines the hiking distance 306 as an upper (or lower, in some embodiments) bound of hiking distances associated with a predicted or determined quantile of hiking distances.

In some embodiments, the arrival determination system 104 receives input (e.g., from an administrator device) to set thresholds (e.g., upper and lower bounds) for quantiles associated with the hiking distance predictor model 304. For example, the arrival determination system 104 receives input to set a number of quantiles as well as bounds of the quantiles such as between the 1^{st} and 10^{th} percentile, between the 1^{st} and 25^{th} percentile, between a 25^{th} and 50^{th} percentile, at a median, between a 50^{th} and 75^{th} percentile, between a 75^{th} and 95^{th} percentile, or some other range. In other embodiments, the arrival determination system 104 determines and/or adjusts quantiles automatically (without user input) based on historical hiking distances from historical transportation requests. For example, the arrival determination system 104 can modify the bounds of the quantiles so that each quantile includes the same or similar numbers of historical hiking distances. Additionally, the arrival determination system 104 receives input (e.g., from an administrator device) to set weights associated with the hiking distance predictor model, and the arrival determination system 104 adjusts the weights automatically based on transportation requests within various quantiles.

In these or other embodiments, the arrival determination system 104 determines which size or resolution of region to utilize in applying the hiking distance predictor model 304 to determine the hiking distance 306. For example, the arrival determination system 104 determines whether to utilize region-specific hiking distances and/or service transportation requests from a GH-6 region associated with the requested pickup location, a GH-7 region associated with the requested pickup location, or a GH-8 region associated with the requested pickup location. To determine which size or resolution of region to use, the arrival determination system 104 determines an accuracy associated with the hiking distance predictor model 304. For example, the arrival determination system 104 determines whether the probability associated with the determined hiking distance 306 (i.e., the probability with which the hiking distance predictor model 304 determines the hiking distance 306 corresponds to the request features 302) satisfies a threshold. If the probability fails to satisfy the threshold, then the arrival determination system 104 utilizes a larger region with more historical information to increase the probability determination.

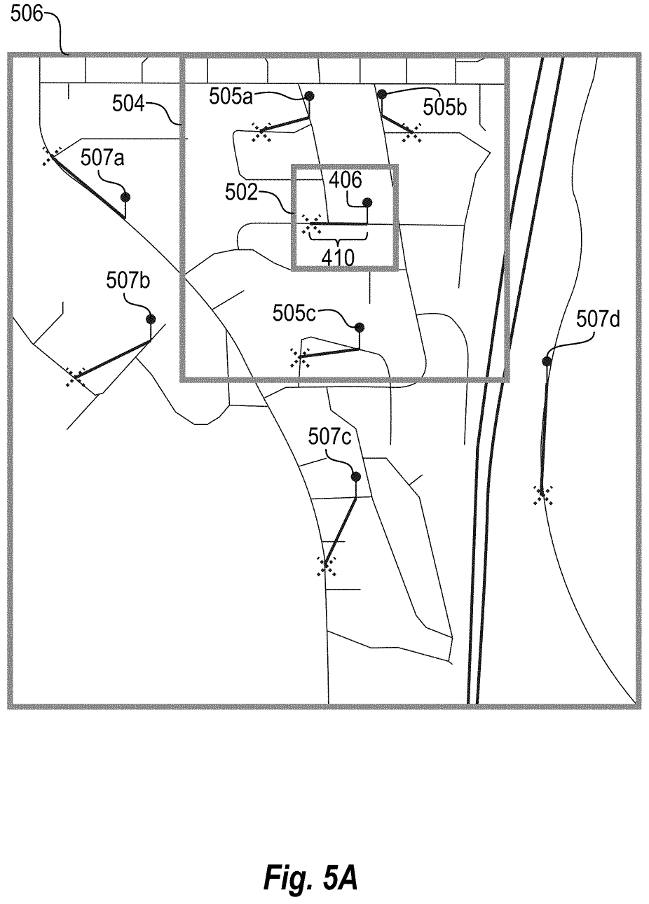

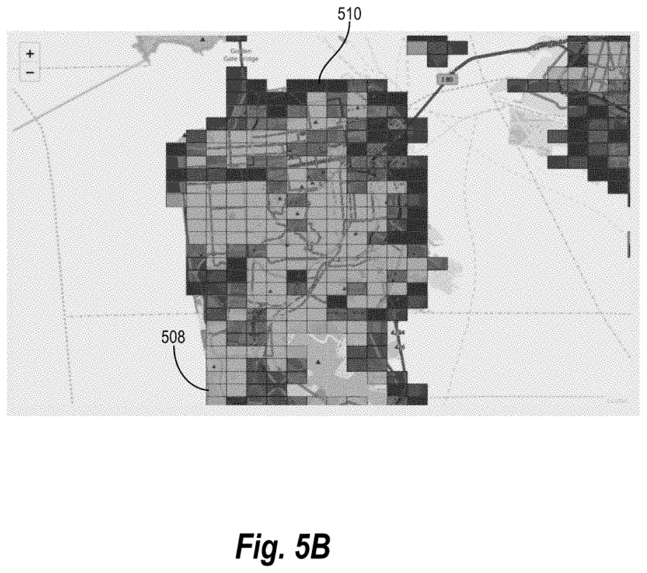

In some embodiments, the arrival determination system 104 determines which region size to use based on an amount of information available from the regions of different sizes. For instance, the arrival determination system 104 determines whether a region of a particular size includes a threshold number of historical transportation requests. Thus, if a smaller region (e.g., a GH-8 region) fails to satisfy the threshold number of historical transportation requests, then the arrival determination system 104 selects a larger region (e.g., a GH-7 region or a GH-6 region) that does satisfy the threshold. For example, the arrival determination system 104 may determine that a smaller region includes a threshold number of requests within a dense city, whereas a larger region is required for a rural area with a lesser density of transportation requests. Additional detail regarding determining a region size for determining a hiking distance is provided below with reference to FIG. 5A.

In some embodiments, the arrival determination system 104 utilizes a modified hiking distance predictor model for transportation requests that originate (or that indicated requested pickup locations) at airports or other venues such as stadiums and arenas. In the same or other embodiments, the arrival determination system 104 utilizes additional or alternative request features for transportation requests that originate at airports or other venues such as stadiums and arenas. Indeed, to analyze the different features to determine a hiking distance, the arrival determination system 104 utilizes a modified hiking distance predictor model trained based on, for example, terminal-specific information, airport-specific information, or other venue-specific information.

To illustrate, the arrival determination system 104 utilizes a modified hiking distance predictor model to determine a hiking distance for a request that indicates a requested pickup location at an airport. For example, the transportation request can include request features that indicate a particular floor or level of the airport (or a parking structure) for a requested pickup location. Thus, the arrival determination system 104 utilizes a modified hiking distance predictor model to determine a hiking distance that includes consideration of the particular pickup floor/level. For instance, the modified hiking distance predictor model can determine a hiking distance that include three-dimensional locations. Thus, if a provider device is directly above or below a requested pickup location, but not on the correct floor/level, the arrival determination system 104 refrains from enabling the provider device to notify the requester of arrival for pickup. Once the arrival determination system 104 detects that the provider device is within the hiking distance in all three dimensions (e.g., latitude, longitude, and elevation) then the arrival determination system 104 causes the provider device to present the selectable option to notify the requester of arrival.

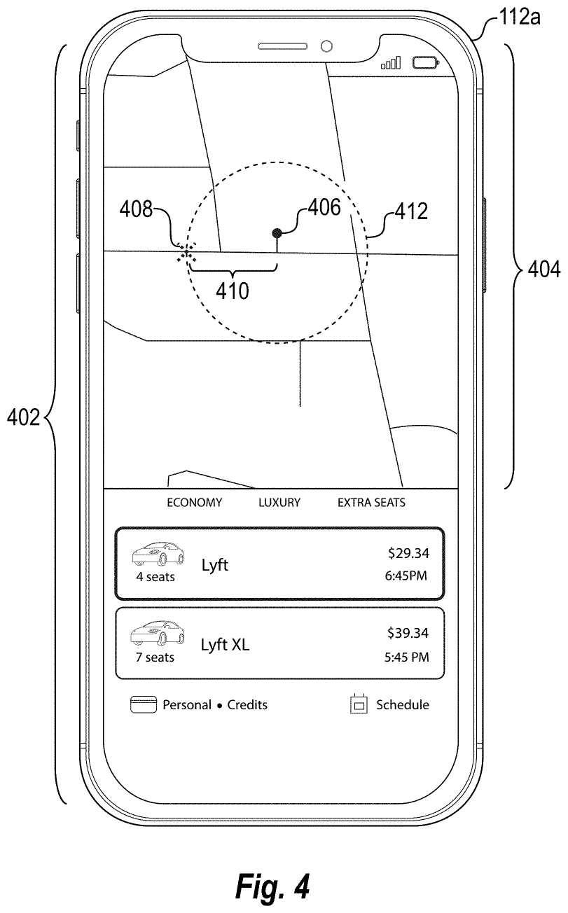

As mentioned, the arrival determination system 104 can determine a hiking distance based on a requested pickup location. FIG. 4 illustrates an example requester device 112a displaying a requester interface 402 (e.g., as part of the requester application 114) that includes a digital map 404 whereby the requester can indicate a requested pickup location 406. As shown in FIG. 4, the requester indicates the requested pickup location 406 via a pin drop—i.e., by selecting a location for a pin within the digital map 404. In some embodiments, the requester indicates a requested pickup location by a different selection method such as by manually entering an address, selecting a particular venue, or search for a location via a search option. To determine a hiking distance, in these or other embodiments, the arrival determination system 104 utilizes historical request features from historical transportation requests that indicate the same requested pickup location selection method as utilized by the requester of a current transportation request.

Based the requested pickup location 406, the arrival determination system 104 determines a hiking distance 410. Indeed, the arrival determination system 104 determines a prediction of a maximum distance that the requester is willing to walk from the requested pickup location 406. For example, FIG. 4 illustrates an actual pickup location 408 (which may or may not displayed on the requester device 112a) for the transportation request which indicates the hiking distance 410 between the requested pickup location 406 and the actual pickup location 408. While FIG. 4 illustrates the actual pickup location 408 within the digital map 404, this is merely illustrative for conceptual understanding of the hiking distance 410, and the arrival determination system 104 need not determine the actual pickup location 408 to determine the hiking distance 410. In some embodiments, however, the arrival determination system 104 can determine the actual pickup location 408 for the transportation request.

By determining the hiking distance 410, the arrival determination system 104 further defines a radius 412 that indicates a distance threshold around the requested pickup location 406 that a provider device (e.g., the provider device 108a) must enter or touch to indicate provider arrival. In some embodiments, the radius 412 is not displayed within the digital map 404, while in other embodiments the requester device 112a displays the radius 412 of the hiking distance 410 around the requested pickup location 406.

To determine the hiking distance 410 based on the requested pickup location 406, the arrival determination system 104 determines request features associated with the transportation request to utilize as input into a hiking distance predictor model (e.g., the hiking distance predictor model 304). For example, the arrival determination system 104 determines region-specific hiking distances associated with historical transportation requests within regions of different sizes that include the requested pickup location 406. FIG. 5A illustrates particular regions associated with the requested pickup location 406 that the arrival determination system 104 analyzes to determine which of the regions to use for identifying request features to input into a hiking distance predictor model (e.g., the hiking distance predictor model 304) to determine the hiking distance 410.

For example, FIG. 5A illustrates a GH-8 region 502 that is a relatively small region that includes the requested pickup location 406. In some embodiments, however, the arrival determination system 104 determines that the GH-8 region 502 does not include enough historical transportation requests to satisfy a threshold (or that the hiking distance predictor model 304 does not generate a probability of a hiking distance that satisfies a probability threshold). Indeed, FIG. 5A illustrates no historical transportation requests within the GH-8 region 502.

Thus, the arrival determination system 104 analyzes additional regions that includes the requested pickup location 406 such as a GH-7 region 504 and a GH-6 region 506. For example, the arrival determination system 104 determines that the GH-7 region 504 includes historical transportation requests that indicate historical requested pickup locations 505a-505c. In addition, the arrival determination system 104 determines or identifies corresponding historical actual pickup locations as indicated by the dashed “x” symbols connected by lines that indicate the historical hiking distances of the historical transportation requests. In some embodiments, the arrival determination system 104 determines that the GH-7 region 504 includes enough historical transportation requests to satisfy a threshold, and the arrival determination system 104 utilizes historical request features associated with the GH-7 region 504 to determine the hiking distance 410. For example, the arrival determination system 104 determines the hiking distance 410 based on the historical hiking distances corresponding to the historical requested pickup locations 505a-505c of the historical transportation requests. In other embodiments, however, the arrival determination system 104 determines that the GH-7 region 504 does not satisfy a threshold number of transportation requests.

As shown, based on determining that the GH-7 region 504 does not include enough historical transportation requests to satisfy a threshold, the arrival determination system 104 analyzes a relatively large GH-6 region 506 to identify historical transportation requests. For instance, the arrival determination system 104 analyzes the GH-6 region 506 to identify the historical requested pickup locations 507a-507d associated with historical transportation requests. Additionally, the arrival determination system 104 determines corresponding historical actual pickup locations (as indicated by the corresponding “x” symbols in FIG. 5A) as well as historical hiking distances (as indicated by the bold lines connecting the historical requested pickup locations 507a-507d with the “x” symbols). In some embodiments, the arrival determination system 104 analyzes regions of different sizes in addition (or alternatively) to the regions illustrated in FIG. 5A based on determining whether the regions of different sizes include a threshold number of historical transportation requests (or that the hiking distance predictor model 304 determines a hiking distance with a threshold probability).

As mentioned, the arrival determination system 104 determines geographic regions (e.g., a size, scale, or resolution of geographic regions) based on densities of information (e.g., historical hiking distances and/or contextual request information) gathered from the geographic regions. FIG. 5B illustrates an example depiction of San Francisco including a number of GH-6 regions indicated by the rectangles. In addition, the shading of the rectangles in FIG. 5B illustrates different hiking distances (e.g., average hiking distances) within the respective regions.

Indeed, the arrival determination system 104 can determine a number of different average hiking distances for different regions utilizing a hiking distance predictor model. For example, the arrival determination system 104 determines longer hiking distances for the region 510 than for the region 508 based on the historical hiking distances and/or the contextual information associated with requests within the region 510 and the region 508. As shown, lighter regions correspond to shorter hiking distances, and darker regions correspond to longer hiking distances.

As mentioned above, the arrival determination system 104 considers the density of information gathered within regions (e.g., GH-6 regions, GH-7 regions, etc.) in determining which resolution or size to use for the regions. Indeed, in some embodiments the arrival determination system 104 determines to utilize larger regions based on less dense information, and the arrival determination system 104 determines to use smaller regions based on more dense information. As shown in FIG. 5B, the arrival determination system 104 determines to utilize GH-6 regions for the area of San Francisco depicted based on density of information gathered from the regions. In some embodiments, the arrival determination system 104 change the size of region based on a time of day, where smaller regions are utilized during busier hours (e.g., prime time hours) and larger regions are used during less busy hours where fewer transportation requests are received.

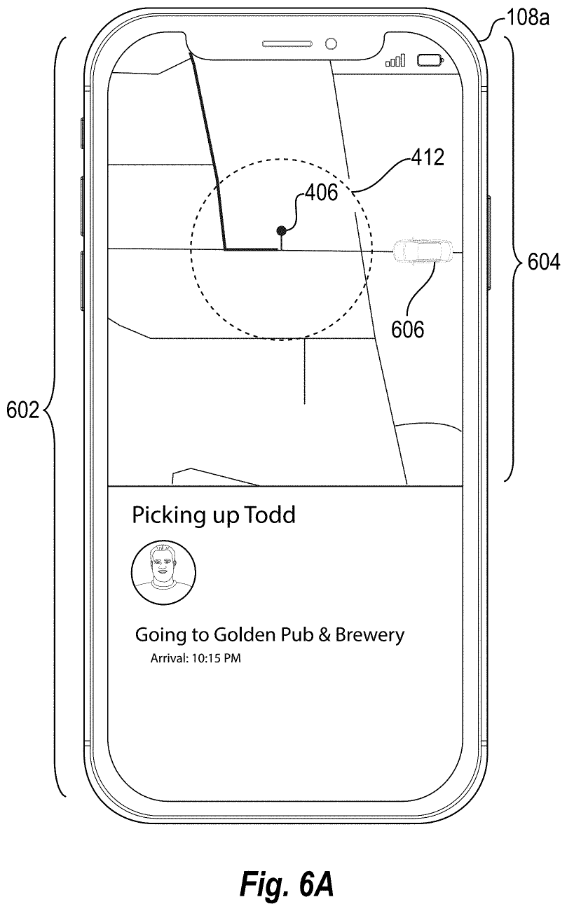

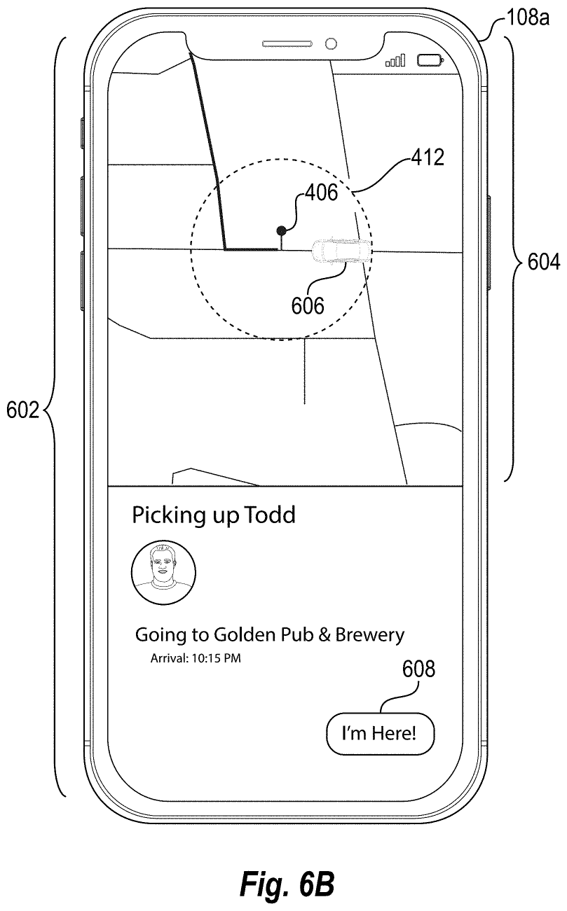

As mentioned, the arrival determination system 104 monitors a location of a provider device (e.g., a provider device 108a) to determine when to enable notification of provider arrival to a requested pickup location (e.g., a requested pickup location 406). FIGS. 6A-6B illustrate an example provider device 108a displaying a provider interface 602 (e.g., as part of a provider application 110) that includes a digital map 604. Within the digital map 604 of FIG. 6A, the provider device 108a presents an illustration of a provider transportation vehicle 606 that represents the transportation vehicle of the provider using the provider device 108a. In addition, the digital map 604 includes a display of the requested pickup location 406. In some embodiments, the digital map 604 also displays the radius 412 that indicates the hiking distance 410 all around the requested pickup location 406. In other embodiments, however, the digital map 604 does not display the radius 412.

Based on monitoring the location of the provider device 108a, the arrival determination system 104 determines when the provider device 108a is within the radius 412—i.e., within the hiking distance 410. Indeed, as shown in FIG. 6A, the arrival determination system 104 determines that the provider device 108a is outside the radius 412, and the arrival determination system 104 therefore prevents the provider device 108a from notifying the requester that the provider has arrived for pickup by refraining from presenting a selectable option to indicate arrival. By contrast, FIG. 6B illustrates the provider device 108a displaying the map 604 that indicates that the provider device 108a is within the radius 412. Thus, based on this determination, the arrival determination system 104 causes the provider device 108a to present the selectable option 608 to indicate to the requester that the provider has arrived for pickup. Indeed, based on receiving an indication that the provider has selected the selectable option 608, the arrival determination system 104 provides a notification to the requester device 112a indicating that the provider has arrived for pickup. In some embodiments, the arrival determination system 104 need not present the selectable option 608, but may instead provide a notification to the requester device 112a automatically in response to detecting that the provider device 108a is within the hiking distance (e.g., for a number of consecutive pings or location requests).

In some embodiments, the arrival determination system 104 dictates when a transportation provider is able to cancel a transportation request because the requester has not arrived at the pickup location. For example, after receiving an indication of arrival of the provider device 108a at the pickup location, the arrival determination system 104 enables the provider device 108a to present a selectable no-show option and/or a selectable cancel option after a predetermined amount of time. For example, once a transportation provider indicates arrival (i.e., in accordance with the features disclosed herein) and then waits an appropriate amount of time for the arrival of the transportation requester (e.g., a predetermined wait time), the arrival determination system 104 then causes the provider device 108a to enable the selectable option for the transportation provider to cancel the transportation request and then become available for another transportation request. Furthermore, the arrival determination system 104 prevents the transportation provider from prematurely canceling a transportation request (e.g., without giving the requester sufficient time to arrive at the pickup location) by requiring the provider device 108a to be within the hiking distance of the pickup location before triggering the beginning of a wait time for the requester to arrive at the pickup location.

As mentioned, the arrival determination system 104 can train a hiking distance predictor model to accurately determine hiking distances based on request features. FIG. 7 illustrates an example training process whereby the arrival determination system 104 trains a hiking distance predictor model 704 (e.g., the hiking distance predictor model 304) based on training data including training transportation request features 702 and corresponding ground truth hiking distances 710.

As illustrated in FIG. 7, the arrival determination system 104 accesses training transportation request features from a database 714. For example, the arrival determination system 104 accesses training transportation request features 702 from one or more historical transportation requests whose information is stored within the database 714. In some embodiments, the arrival determination system 104 considers only successful transportation requests in training the hiking distance predictor model 704. In addition, the arrival determination system 104 inputs the training transportation request features 702 into the hiking distance predictor model 704, whereupon the hiking distance predictor model 704 generates a predicted hiking distance 706 (e.g., an upper or lower bound of a predicted quantile of hiking mdistances). For example, the hiking distance predictor model 704 generates the predicted hiking distance 706 based on training request features such as a region associated with the training request, a time of day associated with the transportation request, and others, as described herein.

Additionally, the arrival determination system 104 performs a comparison 708 to compare the predicted hiking distance 706 with a ground truth hiking distance 710 that reflects the actual hiking distance associated with the training transportation request features 702 of a training transportation request. For example, the arrival determination system 104 compares the predicted hiking distance 706 with the ground truth hiking distance 710 by utilizing a loss function such as a quantile loss function, a cross entropy loss function, a Huber loss function, a mean square error loss function, a mean absolute error loss function, or another appropriate loss function. By utilizing a loss function, the arrival determination system 104 determines an error or measure of loss associated with the hiking distance predictor model 704 in generating predictions of hiking distances.

Based on the comparison 708, the arrival determination system 104 further performs a back propagation 712 to reduce the error or measure of loss. For example, the arrival determination system 104 modifies one or more parameters such as neuron-specific and/or layer-specific weights of the hiking distance predictor model 704 that affect the internal analysis of features in generating a predicted hiking distance. The arrival determination system 104 can repeat the process illustrated in FIG. 7 for multiple iterations or epochs to improve the accuracy of the hiking distance predictor model 704. For each iteration, the hiking distance predictor model 704 selects a new set of training transportation request features, generates a new predicted hiking distances, compares the predicted hiking distance with a ground truth hiking distance that corresponds to the new features, and back propagates to modify weights. Thus, the arrival determination system 104 continually modifies the weights for each iteration to reduce the error or measure of loss until the error or measure of loss satisfies a threshold.

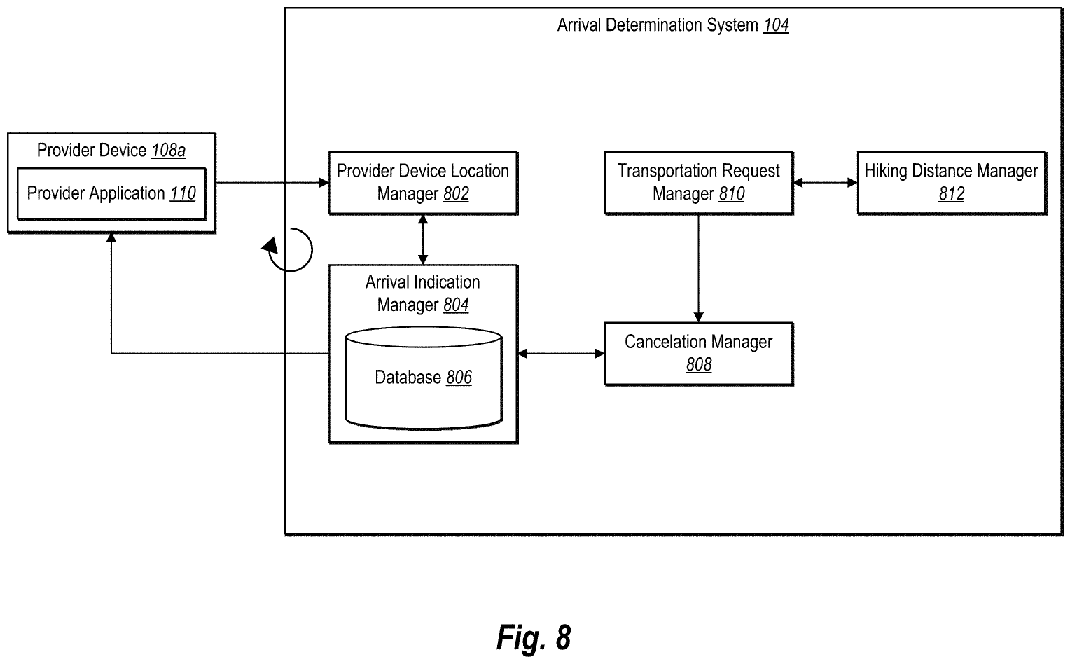

The arrival determination system 104 can have a particular architecture of components for determining hiking distances for transportation requests. Indeed, FIG. 8 illustrates an example architecture of the arrival determination system 104 in accordance with one or more embodiments. As shown in FIG. 8, the arrival determination system 104 includes components such as a provider device location component 802, an arrival indication component 804, a cancelation component 808, a transportation request component 810, and a hiking distance component 812.

The provider device location component 802 communicates with the provider device 108a to determine a location of the provider device 108a. For example, the provider device location component 802 request the location of the provider device 108a and matches the location received from the provider device 108a with a map (e.g., the digital map 404 or 604). In addition, the arrival indication component 804 communicates with the provider device location component 802 to determine when the provider device 108a is within a hiking distance. The arrival indication component 804 further requests the location of the provider device 108a and stores per-request provider device locations within the database 806 (along with timestamps to mark the progress of each sequential location). As shown, the provider device location component 802 and the arrival indication component 804 repeat the determination of the provider device location and the determination of whether the provider device 108a is within a hiking distance on a repeat interval (e.g., 5 seconds).

The arrival indication component 804 further communicates with the cancelation component 808. In particular, the arrival indication component 804 communicates with the cancelation component 808 to provide an indication of whether or not the provider device 108a is within a hiking distance. The cancelation component 808 manages cancelations of transportation requests. For example, the cancelation component 808 communicates with requester devices (e.g., the requester devices 112a-112n) to receive cancelations of transportation requests. Thus, in response to receiving an indication from the arrival indication component 804 that the provider device 108a is within a hiking distance of a requested pickup location, the cancelation component 808 determines that a cancelation received from a requester device (e.g., the requester device 112a) is a post-arrival cancelation (as opposed to a pre-arrival cancelation).

In addition, the arrival determination system 104 includes a transportation request component 810. In particular, the transportation request component 810 manages transportation requests received from requester devices (e.g., the requester devices 112a-112n). For example, the transportation request component 810 receives transportation requests and communicates with the cancelation component 808 to indicate transportation requests to monitor for cancelation. The transportation request component 810 further receives transportation request information including request features. Additionally, the transportation request component 810 communicates with the hiking distance component 812 to provide request features for determining a hiking distance. Indeed, the arrival determination system 104 includes a hiking distance component 812 that manages a hiking distance predictor model to determine a hiking distance based on request features of a transportation request.

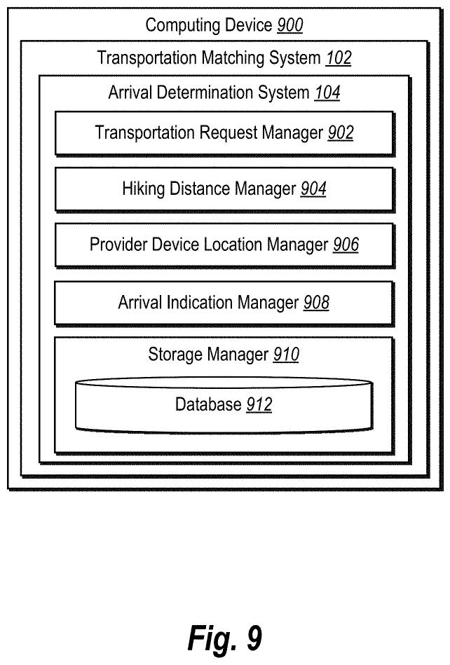

Looking now to FIG. 9, additional detail will be provided regarding components and capabilities of the arrival determination system 104. Specifically, FIG. 9 illustrates an example schematic diagram of the arrival determination system 104 on an example computing device 900 (e.g., one or more of the provider devices 108a-108n, the requester devices 112a-112n, and/or the server(s) 106). As shown in FIG. 9, the arrival determination system 104 may include a transportation request component 902, a hiking distance component 9045, a provider device location component 906, an arrival indication component 908, and a storage component 910.

As mentioned, the arrival determination system 104 includes a transportation request component 902 (e.g., the transportation request component 810). In particular, the transportation request component 902 manages, receives, detects, matches, and/or identifies transportation requests. For example, the transportation request component 902 receives a transportation request and identifies request features from the transportation request. The transportation request component 902 communicates with the storage component 910 to store request features within the database 912. The transportation request component 902 also (or alternatively) communicates with the hiking distance component 904 to provide request features for determining a hiking distance relative to a requested pickup location.

As illustrated in FIG. 9, the arrival determination system 104 includes a hiking distance component 904 (e.g., the hiking distance component 812). In particular, the hiking distance component 904 manages, maintains, stores, trains, utilizes, implements, and/or applies a hiking distance predictor model to determine, generate, or predict a hiking distance for a transportation request. For example, the hiking distance component 904 accesses request features from the database 912 and analyzes the request features to determine a hiking distance in relation to a requested pickup location of a received transportation request. In addition, the hiking distance component 904 trains a hiking distance predictor model based on training data stored in the database 912 (e.g., the database 714 or 806) to determine accurate hiking distances based on request features, as described herein.

As further shown, the arrival determination system 104 includes a provider device location component 906 (e.g., the provider device location component 802). In particular, the provider device location component 906 manages, determines, identifies, detects, and/or monitors locations of provider devices (e.g., the provider devices 108a-108n) such as a provider device matched to a transportation request (e.g., the provider device 108a). For example, the provider device location component 906 detects or determines when a provider device is within a hiking distance of a requested pickup location. The provider device location component 906 further communicates with the arrival indication component 908 to indicate that the provider device is or is not within the hiking distance.

In addition, the arrival determination system 104 includes an arrival indication component 908 (e.g., the arrival indication component 804). In particular, the arrival indication component 908 manages, provides, generates, creates, or determines indications of provider arrival to requested pickup locations. For example, upon determining that a provider device is within a hiking distance of a requested pickup location, the arrival indication component 908 causes or enables a provider device to present or display a selectable option to indicate provider arrival. In some embodiments, the arrival indication component 908 automatically notifies a requester device of provider arrival without necessarily providing an option on a display of a provider device.

In one or more embodiments, each of the components of the arrival determination system 104 are in communication with one another using any suitable communication technologies. Additionally, the components of the arrival determination system 104 can be in communication with one or more other devices including one or more client devices described above. It will be recognized that although the components of the arrival determination system 104 are shown to be separate in FIG. 9, any of the subcomponents may be combined into fewer components, such as into a single component, or divided into more components as may serve a particular implementation. Furthermore, although the components of FIG. 9 are described in connection with the arrival determination system 104, at least some of the components for performing operations in conjunction with the arrival determination system 104 described herein may be implemented on other devices within the environment.

The components of the arrival determination system 104 can include software, hardware, or both. For example, the components of the arrival determination system 104 can include one or more instructions stored on a computer-readable storage medium and executable by processors of one or more computing devices (e.g., the computing device 900). When executed by the one or more processors, the computer-executable instructions of the arrival determination system 104 can cause the computing device 900 to perform the methods described herein. Alternatively, the components of the arrival determination system 104 can comprise hardware, such as a special purpose processing device to perform a certain function or group of functions. Additionally or alternatively, the components of the arrival determination system 104 can include a combination of computer-executable instructions and hardware.

Furthermore, the components of the arrival determination system 104 performing the functions described herein may, for example, be implemented as part of a stand-alone application, as a module of an application, as a plug-in for applications including content management applications, as a library function or functions that may be called by other applications, and/or as a cloud-computing model. Thus, the components of the arrival determination system 104 may be implemented as part of a stand-alone application on a personal computing device or a mobile device. Alternatively or additionally, the components of the arrival determination system 104 may be implemented in any application that allows creation and delivery of marketing content to users, including, but not limited to, various applications.

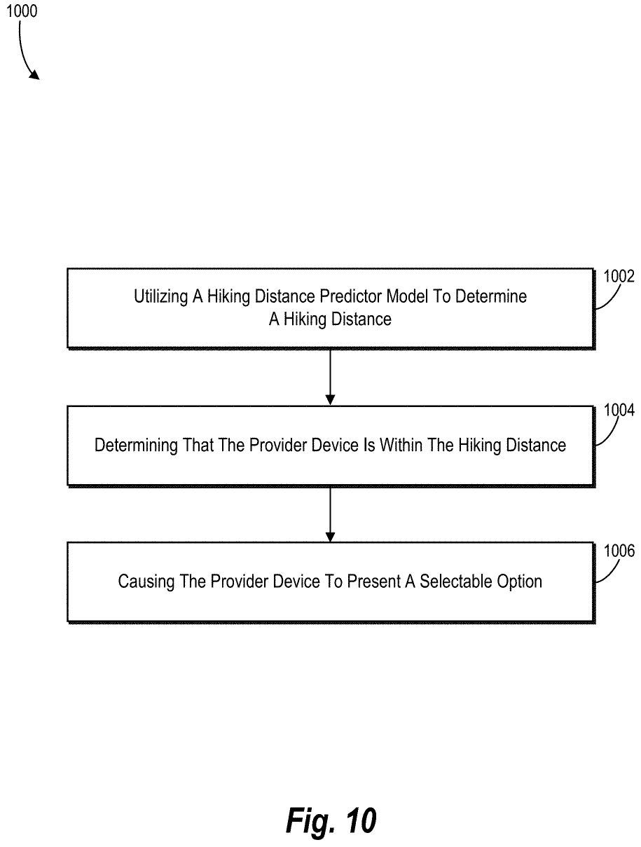

FIGS. 1-9, the corresponding text, and the examples provide a number of different systems, methods, and non-transitory computer readable media for determining a hiking distance for a transportation request and enabling a provider to indicate arrival based on a location of a corresponding provider device. In addition to the foregoing, embodiments can also be described in terms of flowcharts comprising acts for accomplishing a particular result. For example, FIG. 10 illustrates a flowchart of an example sequence of acts in accordance with one or more embodiments.

While FIG. 10 illustrates acts according to some embodiments, alternative embodiments may omit, add to, reorder, and/or modify any of the acts shown in FIG. 10. The acts of FIG. 10 can be performed as part of a method. Alternatively, a non-transitory computer readable medium can comprise instructions, that when executed by one or more processors, cause a computing device to perform the acts of FIG. 10. In still further embodiments, a system can perform the acts of FIG. 10. Additionally, the acts described herein may be repeated or performed in parallel with one another or in parallel with different instances of the same or other similar acts.

FIG. 10 illustrates an example series of acts 1000 for determining a pickup location based on filtering out door points and utilizing a pickup location model. The series of acts 1000 can include an act 1002 of utilizing a hiking distance predictor model to determine a hiking distance. In particular, the act 1002 can include utilizing, for a transportation request received from a requester device, a hiking distance predictor model to determine, based on historical hiking distances within a region associated with the transportation request, a hiking distance associated with the transportation request, wherein the hiking distance indicates a threshold distance from a requested pickup location associated with the transportation request that a provider device must be within to trigger indication of provider arrival for the transportation request. A historical hiking distance can include, for a historical transportation request, a distance from a historical requested pickup location to a corresponding actual pickup location. The act 1002 can involve utilizing the hiking distance predictor model to determine the hiking distance from a given quantile of historical hiking distances. The act 1002 can also (or alternatively) involve utilizing the hiking distance predictor model to analyze a plurality of request features of the transportation request, wherein the plurality of request features comprise two or more of: a requested pickup location selection method, a requester device distance from the requested pickup location, a time of day, a geographic region associated with the transportation request, a region-specific hiking distance, or a region-specific number of serviced transportation requests.

As shown, the series of acts 1000 can also include an act 1004 of determining that the provider device is within the hiking distance. In particular, the act 1004 can involve determining that the provider device is within the hiking distance from the requested pickup location.

Further, the series of acts 1000 can include an act 1006 of causing the provider device to present a selectable option. In particular, the act 1006 can include causing, based on determining that the provider device is within the hiking distance from the requested pickup location, the provider device to present a selectable option to indicate that a provider associated with the provider device has arrived at the pickup location.

The series of acts 1000 can also include an act of determining, from a plurality of regions of different sizes, the region associated with the transportation request by determining that an accuracy associated with the hiking distance predictor model satisfies a threshold based on information collected from the region that has a particular size. The series of acts 1000 can also include an act of training the hiking distance predictor model to determine hiking distances based on training request features from historical transportation requests and corresponding ground truth hiking distances.

Additionally, the series of acts 1000 can include acts of utilizing the hiking distance predictor model to determine a second hiking distance associated with a second transportation request comprising a second requested pickup location, wherein the second hiking distance is different than the hiking distance, determining that a second provider device associated with a second provider is within the second hiking distance from the second requested pickup location, and causing, based on determining that the second provider device is within the second hiking distance, the second provider device to present a second selectable option to indicate that the second provider has arrived at the second requested pickup location.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 (e.g., the computing device 900) that may be configured to perform one or more of the processes described above. One will appreciate that the arrival determination system 104 can comprise implementations of the computing device 1100, including, but not limited to, the provider devices 108a-108n, the requester devices 112a-112n, and/or the server(s) 106. As shown by FIG. 11, the computing device can comprise a processor 1102, memory 1104, a storage device 1106, an I/O interface 1108, and a communication interface 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, storage device 1106 can comprise a non-transitory storage medium described above. The storage device 1106 may include a hard disk drive (“HDD”), flash memory, a Universal Serial Bus (“USB”) drive or a combination of these or other storage devices.

The computing device 1100 also includes one or more input or output interface 1108 (or “I/O interface 1108”), which are provided to allow a user (e.g., requester or provider) to provide input to (such as user strokes), receive output from, and otherwise transfer data to and from the computing device 1100. These I/O interface 1108 may include a mouse, keypad or a keyboard, a touch screen, camera, optical scanner, network interface, modem, other known I/O devices or a combination of such I/O interface 1108. The touch screen may be activated with a stylus or a finger.

The I/O interface 1108 may include one or more devices for presenting output to a user, including, but not limited to, a graphics engine, a display (e.g., a display screen), one or more output providers (e.g., display providers), one or more audio speakers, and one or more audio providers. In certain embodiments, interface 1108 is configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 can provide one or more interfaces for communication (such as, for example, packet-based communication) between the computing device and one or more other computing devices 1100 or one or more networks. As an example, and not by way of limitation, communication interface 1110 may include a network interface controller (“NIC”) or network adapter for communicating with an Ethernet or other wire-based network or a wireless NIC (“WNIC”) or wireless adapter for communicating with a wireless network, such as a WI-FI. The computing device 1100 can further include a bus 1112. The bus 1112 can comprise hardware, software, or both that connects components of computing device 1100 to each other.

FIG. 12 illustrates an example network environment 1200 of the transportation matching system 102. The network environment 1200 includes a client device 1206 (e.g., one or more of the provider devices 108a-108n and/or requester devices 112a-112n), a transportation matching system 102, and a vehicle subsystem 1208 connected to each other by a network 1204. Although FIG. 12 illustrates a particular arrangement of the client device 1206, the transportation matching system 102, the vehicle subsystem 1208, and the network 1204, this disclosure contemplates any suitable arrangement of client device 1206, the transportation matching system 102, the vehicle subsystem 1208, and the network 1204. As an example, and not by way of limitation, two or more of client device 1206, the transportation matching system 102, and the vehicle subsystem 1208 communicate directly, bypassing network 1204. As another example, two or more of client device 1206, the transportation matching system 102, and the vehicle subsystem 1208 may be physically or logically co-located with each other in whole or in part.

Moreover, although FIG. 12 illustrates a particular number of client devices 1206, transportation matching systems 102, vehicle subsystems 1208, and networks 1204, this disclosure contemplates any suitable number of client devices 1206, transportation matching system 102, vehicle subsystems 1208, and networks 1204. As an example, and not by way of limitation, network environment 1200 may include multiple client device 1206, transportation matching system 102, vehicle subsystems 1208, and/or networks 1204.

This disclosure contemplates any suitable network 1204. As an example, and not by way of limitation, one or more portions of network 1204 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1204 may include one or more networks 1204.

Links may connect client device 1206, arrival determination system 104, and vehicle subsystem 1208 to network 1204 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1200. One or more first links may differ in one or more respects from one or more second links.

In particular embodiments, the client device 1206 may be an electronic device including hardware, software, or embedded logic components or a combination of two or more such components and capable of carrying out the appropriate functionalities implemented or supported by client device 1206. As an example, and not by way of limitation, a client device 1206 may include any of the computing devices discussed above in relation to FIG. 11. A client device 1206 may enable a network user at the client device 1206 to access network 1204. A client device 1206 may enable its user to communicate with other users at other client devices 1206.

In particular embodiments, the client device 1206 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1206 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1206 one or more Hyper Text Markup Language (“HTML”) files responsive to the HTTP request. The client device 1206 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 102 may be a network-addressable computing system that can host a transportation matching network. The transportation matching system 102 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 102. In addition, the transportation matching system 102 may manage identities of service requesters such as users/requesters. In particular, the transportation matching system 102 may maintain requester data such as driving/riding histories, personal data, or other user data in addition to navigation and/or traffic management services or other location services (e.g., GPS services).

In particular embodiments, the transportation matching system 102 may manage transportation matching services to connect a user/requester with a vehicle and/or provider. By managing the transportation matching services, the transportation matching system 102 can manage the distribution and allocation of resources from vehicle systems and user resources such as GPS location and availability indicators, as described herein.

The transportation matching system 102 may be accessed by the other components of network environment 1200 either directly or via network 1204. In particular embodiments, the transportation matching system 102 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1206, or a transportation matching system 102 to manage, retrieve, modify, add, or delete, the information stored in data store.

In particular embodiments, the transportation matching system 102 may provide users with the ability to take actions on various types of items or objects, supported by the transportation matching system 102. As an example, and not by way of limitation, the items and objects may include transportation matching networks to which users of the transportation matching system 102 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 102 or by an external system of a third-party system, which is separate from transportation matching system 102 and coupled to the transportation matching system 102 via a network 1204.

In particular embodiments, the transportation matching system 102 may be capable of linking a variety of entities. As an example, and not by way of limitation, the transportation matching system 102 may enable users to interact with each other or other entities, or to allow users to interact with these entities through an application programming interfaces (“API”) or other communication channels.

In particular embodiments, the transportation matching system 102 may include a variety of servers, sub-systems, programs, modules, logs, and data stores. In particular embodiments, the transportation matching system 102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requester profile) store, connection store, third-party content store, or location store. The transportation matching system 102 may also include suitable components such as network interfaces, security mechanisms, load balancers, failover servers, management-and-network-operations consoles, other suitable components, or any suitable combination thereof. In particular embodiments, the transportation matching system 102 may include one or more user-profile stores for storing user profiles for transportation providers and/or transportation requesters. A user profile may include, for example, biographic information, demographic information, behavioral information, social information, or other types of descriptive information, such as interests, affinities, or location.

The web server may include a mail server or other messaging functionality for receiving and routing messages between the transportation matching system 102 and one or more client devices 1206. An action logger may be used to receive communications from a web server about a user's actions on or off the transportation matching system 102. In conjunction with the action log, a third-party-content-object log may be maintained of user exposures to third-party-content objects. A notification controller may provide information regarding content objects to a client device 1206. Information may be pushed to a client device 1206 as notifications, or information may be pulled from client device 1206 responsive to a request received from client device 1206. Authorization servers may be used to enforce one or more privacy settings of the users of the transportation matching system 102. A privacy setting of a user determines how particular information associated with a user can be shared. The authorization server may allow users to opt in to or opt out of having their actions logged by the transportation matching system 102 or shared with other systems, such as, for example, by setting appropriate privacy settings. Third-party-content-object stores may be used to store content objects received from third parties. Location stores may be used for storing location information received from client devices 1206 associated with users.

In addition, the vehicle subsystem 1208 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1208 can include an autonomous vehicle—i.e., a vehicle that does not require a human operator. In these embodiments, the vehicle subsystem 1208 can perform maneuvers, communicate, and otherwise function without the aid of a human provider, in accordance with available technology.

In particular embodiments, the vehicle subsystem 1208 may include one or more sensors incorporated therein or associated thereto. For example, sensor(s) can be mounted on the top of the vehicle subsystem 1208 or else can be located within the interior of the vehicle subsystem 1208. In certain embodiments, the sensor(s) can be located in multiple areas at once—i.e., split up throughout the vehicle subsystem 1208 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1208 may include a communication device capable of communicating with the client device 1206 and/or the arrival determination system 104. For example, the vehicle subsystem 1208 can include an on-board computing device communicatively linked to the network 1204 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, at a provider device, a transportation request that indicates a requested pickup location from a requester device;
determining, based on historical hiking distances and contextual request information within a region associated with the transportation request, a hiking distance associated with the transportation request;
determining, based on a location of the provider device, that the provider device is within the hiking distance from the requested pickup location; and
presenting, in response to determining that the provider device is within the hiking distance from the requested pickup location, a selectable option to indicate that the provider device has arrived at the requested pickup location.

2. The method of claim 1, wherein a size of the region associated with the transportation request is based on a density of historical hiking distances and contextual request information.

3. The method of claim 1, wherein a historical hiking distance comprises a distance from a historical requested pickup location to a corresponding actual pickup location.

4. The method of claim 1, wherein determining the hiking distance associated with the transportation request is based on quantiles or percentiles of historical hiking distances.

5. The method of claim 1, further comprising training a hiking distance predictor model based on training request features from historical transportation requests and corresponding ground truth hiking distances.

6. The method of claim 1, wherein the contextual request information comprises one or more of a transportation request location, provider availability information, a requested pickup location selection method, a requester device distance from the requested pickup location, a time of day, a geographic region associated with the transportation request, a region-specific hiking distance, or a region-specific number of serviced transportation requests.

7. The method of claim 1, further comprising:
determining a second hiking distance associated with a second transportation request including a second requested pickup location;
determining that the provider device is within the second hiking distance from the second requested pickup location; and
presenting, in response to determining that the provider device is within the second hiking distance, the selectable option to indicate that the provider device has arrived at the second requested pickup location.

8. A non-transitory computer readable medium comprising instructions that, when executed by at least one processor, cause a computer device to:
receive, at a provider device, a transportation request that indicates a requested pickup location from a requester device;
determine, based on historical hiking distances and contextual request information within a region associated with the transportation request, a hiking distance associated with the transportation request;
determine, based on a location of the provider device, that the provider device is within the hiking distance from the requested pickup location; and
present, in response to determining that the provider device is within the hiking distance from the requested pickup location, a selectable option to indicate that the provider device has arrived at the requested pickup location.

9. The non-transitory computer readable medium of claim 8, wherein a size of the region associated with the transportation request is based on a density of historical hiking distances and contextual request information.

10. The non-transitory computer readable medium of claim 8, wherein a historical hiking distance comprises a distance from a historical requested pickup location to a corresponding actual pickup location.

11. The non-transitory computer readable medium of claim 8, wherein the instructions cause the computer device to determine the hiking distance associated with the transportation request based on quantiles or percentiles of historical hiking distances.

12. The non-transitory computer readable medium of claim 8, further comprising instructions that, when executed by the at least one processor, cause the computer device to train a hiking distance predictor model based on training request features from historical transportation requests and corresponding ground truth hiking distances.

13. The non-transitory computer readable medium of claim 8, wherein the contextual request information comprises one or more of a transportation request location, provider availability information, a requested pickup location selection method, a requester device distance from the requested pickup location, a time of day, a geographic region associated with the transportation request, a region-specific hiking distance, or a region-specific number of serviced transportation requests.

14. The non-transitory computer readable medium of claim 8, further comprising instructions that, when executed by the at least one processor, cause the computer device to:
determine a second hiking distance associated with a second transportation request including a second requested pickup location;
determine that the provider device is within the second hiking distance from the second requested pickup location; and
presenting, in response to determining that the provider device is within the second hiking distance, the selectable option to indicate that the provider device has arrived at the second requested pickup location.

15. A system comprising:
at least one processor; and
a non-transitory computer readable medium comprising instructions that, when executed by the at least one processor, cause the system to:
receive, at a provider device, a transportation request that indicates a requested pickup location from a requester device;
determine, based on historical hiking distances and contextual request information within a region associated with the transportation request, a hiking distance associated with the transportation request;
determine, based on a location of the provider device, that the provider device is within the hiking distance from the requested pickup location; and
present, in response to determining that the provider device is within the hiking distance from the requested pickup location, a selectable option to indicate that the provider device has arrived at the requested pickup location.

16. The system of claim 15, wherein a size of the region associated with the transportation request is based on a density of historical hiking distances and contextual request information.

17. The system of claim 15, wherein a historical hiking distance comprises a distance from a historical requested pickup location to a corresponding actual pickup location.

18. The system of claim 15, wherein the instructions cause the system to determine the hiking distance associated with the transportation request based on quantiles or percentiles of historical hiking distances.

19. The system of claim 15, further comprising instructions that, when executed by the at least one processor, cause the system to train a hiking distance predictor model based on training request features from historical transportation requests and corresponding ground truth hiking distances.

20. The system of claim 15, wherein the contextual request information comprises one or more of a transportation request location, provider availability information, a requested pickup location selection method, a requester device distance from the requested pickup location, a time of day, a geographic region associated with the transportation request, a region-specific hiking distance, or a region-specific number of serviced transportation requests.
